(19) United States
(12) Patent Application Publication
(10) Pub. No.: US 2020/0118073 A1
(43) Pub. Date: Apr. 16, 2020

(54) BLOCKCHAINS FOR SECURED TRANSPORT OF A TANGIBLE FINANCIAL PRODUCT

(71) Applicant: Capital One Services, LLC, McLean, VA (US)

(72) Inventors: Jeremy J. Phillips, Brooklyn, NY (US); Kurry Tran, Brooklyn, NY (US)

(73) Assignee: Capital One Services, LLC, McLean, VA (US)

(21) Appl. No.: 16/156,838

(22) Filed: Oct. 10, 2018

(51) Int. Cl. G06Q 10/08; G06Q 20/36; G06Q 20/40; H04L 9/06; G06F 17/30

(52) U.S. Cl. CPC G06Q 10/0834; G06Q 10/0833; G06Q 20/367; H04L 2209/38; H04L 9/0643; G06F 17/30185; G06Q 20/4014

(57) ABSTRACT

Provided, in an aspect, is a method for improving security of transporting a tangible financial product using blockchain. The method includes, receiving, from a financial services computer network, a product identifier for a financial product to be transported to a select recipient; recording the product identifier in a blockchain; determining select transport details for the financial product, wherein the select transport details include a select courier signifier and a select location zone; receiving, in response to a holder scanning a transported product, the product identifier and actual transport details, comparing the actual transport details with the select transport details; communicating with the financial services computer network, in response to determining that there is a discrepancy between the holder signifier and the select courier signifier or between the scan location and the select location zone, to disallow the use of the financial product.

### BACKGROUND

Distributed electronic ledgers, such as block chains, have generated interest in a variety of fields as a decentralized data storage mechanism with reliable redundant validation. Blockchain is a technology that can allow authenticated data communication between each player in a supply chain without the intermediation of a trusted central organization. By verifying and adding data in real time, blockchain may increase transparency across a supply chain.

Blockchain technology (sometimes simply referred to as blockchain) is a relatively new technology that has been used in digital currency implementations. It is described in a 2008 article by Satoshi Nakamoto, called “Bitcoin: A Peer-to-Peer Electronic Cash System,” the entire contents of which are hereby incorporated by reference. The blockchain is a data structure that stores a list of transactions and can be thought of as a distributed electronic ledger that records transactions between source identifier(s) and destination identifier(s). The transactions are bundled into blocks and every block (except for the first block) refers back to or is linked to a prior block in the chain. Computer nodes maintain the blockchain and cryptographically validate each new block, and thus, the transactions contained in the corresponding block. This validation process includes solving a computationally difficult problem that is also easy to verify and is sometimes called a “proof-of-work.”

Currently, it is difficult to verify the authenticity of such transactions recorded in the distributed electronic ledger, especially while receiving financial products such as bank cards, cash, checks, etc. for the first time, or accepting them as a form of payment for online transactions. There is also potential for counterfeiting of these financial products. Moreover, such transactions are often performed in a less secure online environment.

### SUMMARY

In an aspect of the present disclosure, a method for improving security of transporting a tangible financial product, includes, receiving, from a financial services computer network, a product identifier for a financial product to be transported to a select recipient; recording the product identifier in a blockchain; determining select transport details for the financial product, wherein the select transport details comprise a select courier signifier and a select location zone; receiving, in response to a holder scanning a transported product, the product identifier and actual transport details, comparing the actual transport details with the select transport details; communicating with the financial services computer network, in response to determining that there is a discrepancy between the holder signifier and the select courier signifier or between the scan location and the select location zone, to disallow the use of the financial product. In some embodiments, the actual transport details include a holder signifier and a scan location.

In some embodiments, the actual transport details originate from the financial product independently of any container. In some embodiments, the financial product includes a radio-frequency identification (RFID) tag that comprises the product identifier. In some embodiments, the financial product includes a chip that comprises the product identifier. In some embodiments, the financial product includes a quick response code that comprises the product identifier. In some embodiments, the financial product includes a text string that includes the product identifier. In some embodiments, the database is a private database accessible only by the financial services computer network.

In some embodiments, the financial services computer network determines a wishlist of couriers for delivering the financial product based on one or more trust scores stored in the blockchain. In some embodiments, the financial services computer network determines the one or more trust scores stored in the blockchain based on a number of successful deliveries by each courier from the wishlist of couriers. In some embodiments, the financial services computer network determines the one or more trust scores stored in the blockchain based on a number of smart contracts enforced by each courier from the wishlist of couriers.

In some embodiments, the method includes, receiving, from the financial services computer network, a second product identifier for a second financial product to be transported to a second select recipient at a second select delivery location; recording the second product identifier in the blockchain; determining second select transport details for the second financial product, wherein the second select transport details comprise a second select courier signifier and a second select location zone; receiving, in response to a second holder scanning a second transported product, the second product identifier and second actual transport details, wherein the second actual transport details comprise a second holder signifier and a second scan location; comparing the second actual transport details with the second select transport details to determine that there is no discrepancy; receiving, in response to a second acceptor scanning the second transported product, the second product identifier and a second actual delivery location; comparing the second acceptor with the second select recipient, and the second actual delivery location with the second select delivery location, to determine that there is no discrepancy; and communicating with the financial services computer network to allow the use of the financial product. In some embodiments, the financial product is a bank card. In some embodiments, the method includes receiving from the financial services computer network, in response to an authorized user of the bank card activating the bank card, a report that the bank card has been activated. In some embodiments, the bank card includes a surface that lacks a visible card number.

In some embodiments, the method includes, receiving, from the financial services computer network, in response to an authorized user of the bank card performing a transaction within a pre-defined location known by the financial services computer network, a report that the bank card has been activated. In some embodiments, the method includes, receiving, from the financial services computer network, in response to an authorized user of the bank card activating the bank card, a report that the bank card has been activated.

Another aspect of the disclosure relates to a system for verifying authenticity of a transported financial product. The system includes a database, one or more processors, an initiating module, a tracking module, and a verification module. The initiating module may receive, from a financial services computer network, a product identifier for a financial product to be transported to a select recipient; record the product identifier in a blockchain; and determine select transport details for the financial product, wherein the select transport details comprise a select courier signifier and a select location zone. The tracking module may receive, in response to a holder scanning a transported product, the product identifier and actual transport details, wherein the actual transport details comprise a holder signifier and a scan location; and compare the actual transport details with the select transport details. The verification module may communicate with the financial services computer network, in response to determining that there is a discrepancy between the holder signifier and the select courier signifier or between the scan location and the select location zone, to disallow the use of the financial product. In some embodiments, the blockchain includes a wishlist of couriers. In some embodiments, the financial product is a credit card. In some embodiments, the financial product includes a Bluetooth device that includes the product identifier.

Another aspect of the disclosure relates to a method for securely sending a financial product to a recipient. The method may include, receiving at a financial services computer network a request from a recipient for a financial product; transmitting to a server product information for the financial product, wherein the product information comprises an identifier; transmitting to the server a first scan of the identifier; and transmitting to the server chosen shipment details for the financial product.

In some embodiments, the method includes mailing the financial product within an opaque container that allows scanning of the financial product while the financial product is inside the container. In some embodiments, the method includes transmitting information on activation of the card by an authorized user to the server. In some embodiments, the method includes transmitting, to the server, a location information of a transaction performed by the authorized user of the card. In some embodiments, the location information of the transaction includes one or more pre-defined locations known to the financial services computer network.

### BRIEF DESCRIPTION OF THE DRAWINGS

Various objectives, features, and advantages of the disclosed subject matter can be more fully appreciated with reference to the following detailed description of the disclosed subject matter when considered in connection with the following drawings, in which like reference numerals identify like elements.

FIG. 1 is a block diagram of a system for verifying authenticity of a transported financial product, according to some embodiments of the present disclosure.

FIG. 2A is an illustrative example of a financial product, according to some embodiments of the present disclosure.

FIG. 2B is a block diagram of an intermediary device, according to some embodiments of the present disclosure.

FIG. 3 is a flow diagram showing processing that may occur within the system 100 of FIG. 1, according to some embodiments of the present disclosure.

FIG. 4 is a flow diagram showing processing that may occur within the system 100 of FIG. 1, according to some embodiments of the present disclosure.

FIG. 5 is a block diagram of an example user device using the process performed by the system of FIG. 1, according to an embodiment of the present disclosure.

The drawings are not necessarily to scale, or inclusive of all elements of a system, emphasis instead generally being placed upon illustrating the concepts, structures, and techniques sought to be protected herein.

### DETAILED DESCRIPTION

A blockchain can verify a financial product (e.g. cash, checks, documents or bank cards), a user, a recipient of the financial product, an exchange location and/or time. Trusted members of the blockchain can store this information. In some instances, a smart contract can be established to ensure that the authentic financial products is exchanged to a verified accepter, and also ensure that the transaction itself is acceptable given the rules for the financial product. Trusted members of the blockchain may store the above transaction information constantly. In one example, a user orders cash or check or card to be delivered to them from a financial institution system (e.g., Capital One). The financial institution system receives the order from the user and records the order in the blockchain. The financial institution system scans a cash or check ID number, a bar/QR code, or a unique chip embedded in a bank card (e.g. credit card) which is recorded in the blockchain. The financial institution system selects courier for delivery of the ordered financial product based on one or more trust scores stored on the blockchain. In one example, the one or more trust scores for a courier delivering the ordered financial product can be based on a number of deliveries that were successfully delivered by that courier and/or the ratings received by the courier. In another example, the one or more trust scores for a courier delivering the ordered financial product can be based on a number of smart contracts (that ensures that an authentic financial product is exchanged to a verified accepter) verified and enforced by the courier. The user receives the ordered financial product at a desired location. The financial institution system may verify information such as location, time, ID number, bar/QR code, or scans unique to a chip in the bank card and then stores the verified information periodically in the blockchain.

With the blockchain based approach, disclosed herein, a sender of the financial product may not be able to revoke the ownership of the financial product to the recipient of the financial product without good cause. It is in this case that the blockchain based approach can be leveraged, smart contracts can be consulted, and a distributed network can validate the claim of ownership to the new owner of the financial product or the previous owner of the financial product. As an example, if Bob sells a home to Alice for $1 M and gives Alice the title, and then the price of the sold home went up to $2 M, the distributed network in the blockchain based approach would prevent Bob from revoking the title without a reasonable and/or legal cause.

Disclosed in the present disclosure, in one aspect, is a method for improving security of transporting a tangible financial product. The method can include, receiving, from a financial services computer network, a product identifier for a financial product to be transported to a select recipient; recording the product identifier in a database; determining select transport details (e.g. a select courier signifier and a select location zone) for the financial product; receiving, in response to a holder scanning a transported product, the product identifier and actual transport details, comparing the actual transport details with the select transport details; communicating with the financial services computer network, in response to determining that there is a discrepancy between the holder signifier and the select courier signifier or between the scan location and the select location zone, to disallow the use of the financial product.

### Applications

In one aspect, the present disclosure ensures the authenticity of cash, checks, and/or banks cards, cashier's checks, documents, or cash with a special sensor or a scannable symbol, a tile for an automobile/motorcycle, a title for a property (i.e. homes, condos, buildings, etc.). The present disclosure can allow the recipient of the financial product to verify validity and authenticity of the financial product. The present disclosure can also allow the sender of the financial product to activate it or deactivate it (similar to cancelling an issued check). In another aspect, the present disclosure ensures faster delivery times by having more trusted custodians at each step, and also provides faster support and conflict resolution.

### System Architecture

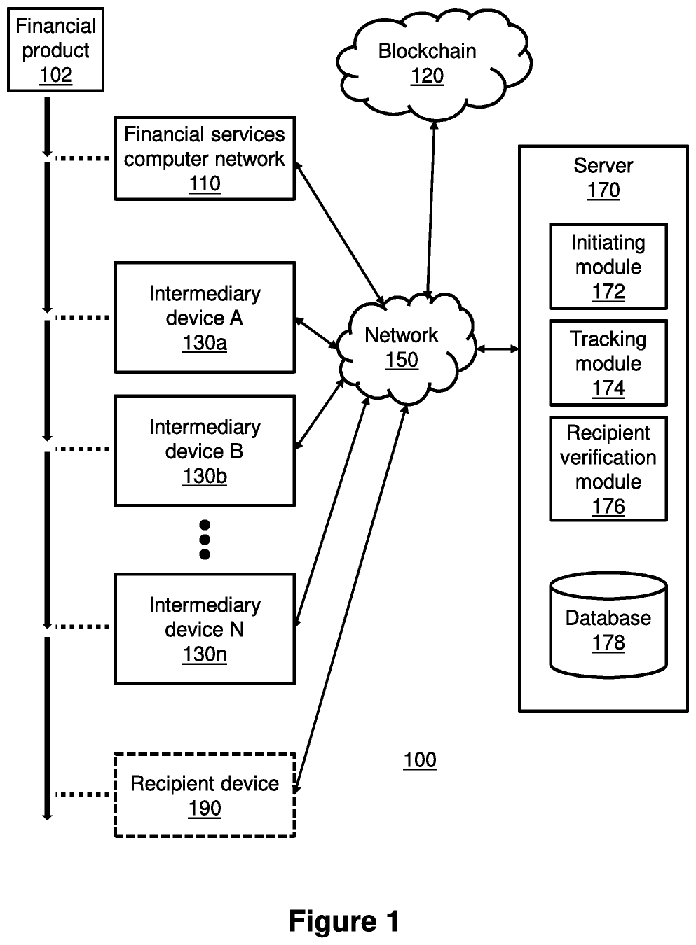

FIG. 1 is a block diagram of a system 100 for verifying authenticity of a transported financial product, according to some embodiments of the present disclosure. The system 100 shown by FIG. 1 comprises a financial product 102, a financial services computer network 110, one or more intermediary devices 130, a network 150, a server 170 and a recipient device 190. As shown in FIG. 1, the server 170 can include an initiating module 172, a tracking module 174, a recipient verification module 176, and a database 178. In alternative configurations, different and/or additional components may be included in the system 100.

The financial product 102 can be a tangible entity transported from a financial institution system to a recipient. In one example, the financial product 102 can be a bank card such as a credit card or a debit card. In another example, the financial product 102 can be a check issued by a financial institution system (e.g. a personal check, a cashier's check, a money order, a cash with a special sensor or scannable symbol, etc.). In another example, the financial product 102 can be a financial document such as a Title Certificate for an automobile (e.g. a car, a motorcycle, etc.) or a home.

In some embodiments, the financial product 102 includes at least one of a radio-frequency identification (RFID) tag, a chip, a quick response (QR) code, and a text string that includes a product identifier associated with the financial product 102. In some embodiments, the financial product 102 includes a Bluetooth device that includes the product identifier. In alternate embodiments, the financial product 102 is a bank card that includes a surface that lacks a visible card number.

The financial services computer network 110 can include one or more financial services computers associated with a financial institution system (e.g. Capital One). In some configurations, the financial services computer network 110 can receive product identifier information associated with a financial product and determine a select transport detail (e.g. a select courier signifier, a select location zone) corresponding to the received product identifier information. In some embodiments, the financial services computer network 110 can include a wallet application (e.g., a mobile wallet application or an application executable on a desktop computer). The wallet application is capable of initiating transactions denominated in one or more currencies, including crypto-currencies such as Bitcoin™.

The financial services computer network 110 can store blockchain wallet information in a blockchain 120. The blockchain 120 is a software and hardware, or specifically designed hardware, that can store information that allows an individual to make electronic commerce transactions. In some embodiments, the financial services computer network 110 can communicate with a blockchain computer system (not shown here). The blockchain computer system can include one or more nodes that store a distributed ledger. The financial services computer network 110 can store one or more (usually two) ordered lists of data transaction requests received from remote computing devices such as the intermediary device 130a.

Each of the intermediary devices 130 may include a computing device, such as a hashing computer, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), a point-of-sale terminal (POS), and/or any other type of computing device that may be configured to store data and software instructions, execute software instructions to perform operations, and/or display information on a display device). In some configurations, the intermediary devices 130 may execute a stored software application (e.g. a wallet application) capable of obtaining a current version of a conventional block-chain ledger from one or more networked computer systems. At least one of the intermediary devices 130 may be a point-of-sale (POS) terminal and/or an internet commerce server.

Each of the intermediary devices 130 can include one or more tangible, non-transitory memories that store data and/or software instructions, and one or more processors configured to execute software instructions. The intermediate device 130 may include one or more display devices that display information to a user and one or more input devices (e.g., keypad, keyboard, touchscreen, voice activated control technologies, or any other type of known input device) to allow the user to input information to the client device. In one aspect, each of the intermediary devices 130 stores in memory one or more software applications that run on the intermediate device and are executed by the one or more processors. In some instances, each intermediate device stores software applications that, when executed by one or more processors, perform operations that establish communications with a financial institution. Each of the intermediary devices 130 may execute the stored software application(s) to generate a transaction that includes data identifying one or more tangible financial products, a public key of one or more users, and/or additional transaction data. The executed software applications may cause the intermediary devices 130 to transmit the data specifying the tangible financial product.

Each of the financial services computer network 110, the one or more intermediary devices 130, the server 170, and the recipient device 190, can communicate via the network 150, which may include any combination of local area and/or wide area networks, using both wired and/or wireless communication systems. In one embodiment, the network 150 uses standard communications technologies and/or protocols. For example, the network 150 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 150 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 150 may be represented using any suitable format, such as hypertext markup language (HTML) or extensible markup language (XML). In some embodiments, all or some of the communication links of the network 150 may be encrypted using any suitable technique or techniques.

In the depicted example of FIG. 1, the network 150 is the Internet with the network 150 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational, and other computer systems that route data and messages. Of course, the network 150 also may be implemented as a number of different types of networks, such as for example, an intranet, a local area network (LAN), or a wide area network (WAN). Also, it should be noted that the network 150 may include any number of additional server devices, client devices, and other devices not shown. Program code located in the network 150 may be stored on a computer recordable storage medium and downloaded to a computer or other device for use. For example, program code may be stored on a computer recordable storage medium on the server 170 and downloaded to the intermediate device 130a over the network 150 for use on the intermediate device 130a. FIG. 1 is intended as an example, and not as an architectural limitation for the different illustrative embodiments.

The server 170 can include one or more computing devices that can execute software instructions to perform one or more processes in accordance with various embodiments. In one example, the server 170 is a computing device that executes software instructions to perform operations that provide information to at least one other component of the system 100. In one embodiment, the server 170 includes a computer (e.g., a personal computer, network computer, or mainframe computer) having one or more processors that are selectively activated or reconfigured by a computer program. In one aspect, the server 170 (or other computing components of system 100) may provide one or more websites, digital portals, etc., that provide services consistent with the financial services computer network 110, such as a digital banking or POS terminal transaction portal. For instance, the server 170 may receive actual transport details (e.g. a holder signifier, a scan location) from the intermediate device 130 and select transport details (e.g. select courier signifier, a select location zone) from the financial services computer network 110.

Referring again to FIG. 1, the server 170 includes the initiating module 172, the tracking module 174, the recipient verification module 176, and the database 178. The initiating module 172 can receive, from the financial services computer network 110, a product identifier for the financial product 102 to be transported to a select recipient; record the product identifier in the database 178; and determine select transport details for the financial product 102. In some configurations, the select transport details can include a select courier signifier and a select location zone. For example, the select courier signifier can have a courier for delivery of the tangible financial product such as “UPS” or “FedEx” and the select location zone can have a value such as “Boston, Mass.” The tracking module 174 can receive, in response to a holder scanning a transported financial product, the product identifier and actual transport details, and compare the actual transport details with the select transport details. In some configurations, the actual transport details can include a holder signifier and a scan location. For example, the holder signifier can have information such as a time of receipt (e.g. 11 PM ET) of the transported financial product, a bar/QR code, an information generated from scanning a unique chip on the transported financial product, or a scan location such as “Los Angeles, Calif.” In the above example, the server 170 can record in a blockchain and/or distributed ledger, a courier handoff in the blockchain, and can also specify that the courier handoff cannot be repeated or used by a previous holder of the financial product. In case, if a first courier handed the transported financial product to a second courier, then the first courier could no longer use the transported financial product. The recipient verification module 176 can communicate with the financial services computer network 110, in response to determining that there is a discrepancy between the holder signifier and the select courier signifier or between the scan location and the select location zone, to disallow the use of the financial product 102. For example, the recipient verification module 176 can communicate a notification such as “Unauthorized use of credit card is detected” to the financial services computer network 110 when the scan location is “Los Angeles, Calif.” while the select location zone is “Boston, Mass.” In some embodiments, the database 178 is a private database accessible only by the financial services computer network 110. The database 178 can include a wishlist of couriers for delivering the financial product 102 to a recipient. The financial services network 110 can determine the wishlist of couriers based on one or more trust scores stored on a blockchain. In one example, the one or more trust scores for a courier delivering the ordered financial product can be based on a number of deliveries that were successfully delivered by that courier and/or the ratings received by the courier. In another example, the one or more trust scores for a courier delivering the ordered financial product can be based on a number of smart contracts (that ensure that an authentic financial product is exchanged to a verified accepter) verified and enforced by the courier.

In other aspects, the server 170 (or other computing components of system 100) may provide information to one or more application programs executed by the intermediary devices 130, e.g., through a corresponding application programming interface (API). For example, the intermediate device 130a may execute an application program associated with and provided by the financial services computer network 110, such as a mobile banking application, point-of-sale applications, and/or a mobile wallet application, to provide services such as communicating with the financial services computer network 110, in response to determining that there is a discrepancy between the holder signifier and the select courier signifier or between the scan location and the select location zone, to disallow the use of a transported financial product 102.

The recipient device 190 can be a computing device capable of sending a request from a recipient of a financial product to a financial institution system. For example, the recipient of the financial product is a holder of a credit card issued by a financial institution system such as Capital One. In some embodiments, the recipient device 190 may receive an activation from a recipient of the financial product 102 and send a report to the server 170 that the financial product 102 has been activated by an authorized user of the financial product 102. The activation of the credit card may also be contingent on the transactions recorded in the database 120, or alternatively a smart contract that ensures that the financial product 102 was properly delivered from the financial institution system. In one example, the recipient device 190 can transmit to the server 170 a product identifier information for a financial product (e.g. a bank card), a first scan of the product identifier, and a chosen shipment details for the financial product.

In some embodiments, the financial services computer network 110 can also conclude a verification block in the transaction records of the blockchain 120, which may be geo-fenced (i.e. spatially constrained). For example, once the financial product 102 is received by the authorized user, the user may perform a transaction using a mobile device within a geo-fence, or use the financial product 102 at a pre-defined known location (e.g. ATM, Local Branch Office of the financial institution system) to automatically close the chain of custody and activate the financial product 102. In alternate configurations, the financial services computer network 110 can conclude the verification block of the blockchain 120 during the shipping of the financial product 102 from the financial institution system.

### Example of a Transported Financial Product

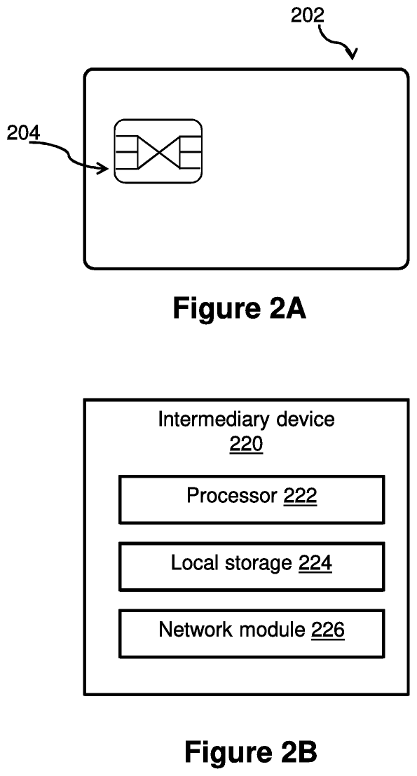

FIG. 2A is an illustrative example of a financial product 202, according to some embodiments of the present disclosure. The financial product 202 can be an example of the financial product 102 of FIG. 1. The financial product 202 can be a bank card (e.g. credit card) that includes a chip 204 that stores a product identifier corresponding to the bank card. In some configurations, the product identifier includes a radio-frequency identification (RFID) tag. A financial institution system (e.g. Capital One) can transport the financial product 202 to a recipient. In one example, the financial institution system can send the financial product 202 by mail within an opaque container that allows scanning of the financial product 202 while the financial product 202 is inside the container. In another example, the financial product 202 includes a Bluetooth device that includes the product identifier. In yet another example, the financial product 102 is a bank card that can be activated by an authorized user of the bank card.

FIG. 2B is a block diagram of an intermediary device 202, according to some embodiments of the present disclosure. The intermediary device 202 can be an example of the intermediary device 130, as described above in conjunction with FIG. 1. The intermediary devices 202 may include one or more computing devices that can store data and software instructions, execute software instructions to perform operations, and/or display information on a display device. The intermediary device 202 can include a processor 222, a local storage 224, and a network module 226. The local storage 224 includes one or more tangible, non-transitory memories that store data and/or software instructions, and one or more processors configured to execute software instructions. In one aspect, the intermediary device 202 stores in the local storage 224 one or more software applications that run on the intermediate device 202 and are executed by the processor 222. In some instances, the intermediate device 202 stores software applications that, when executed by the processor 222, perform operations that establish communications with a financial institution through the network module 226. The intermediary device 202 may execute the stored software application(s) to generate a transaction that includes data identifying one or more tangible financial products, a public key of one or more users, and/or additional transaction data. The executed software applications may cause the intermediary device 202 to transmit the data specifying the tangible financial product.

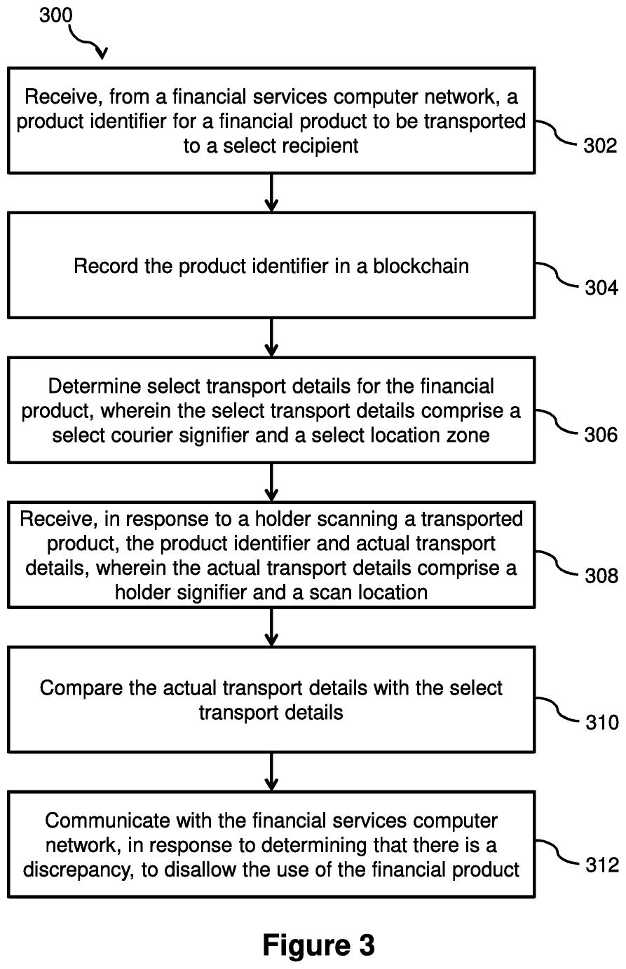

FIG. 3 is a flow diagram 300 showing processing that may occur within the system 100 of FIG. 1, according to some embodiments of the present disclosure. The flow diagram 300 of FIG. 3 may be performed by the system 100. Other entities may perform some or all of the steps of the process in other embodiments. Likewise, embodiments may include different and/or additional steps, or perform the steps in different orders.

The system 100 can receive 302 from a financial services computer network, a product identifier for a financial product to be transported to a select recipient. As described above in conjunction with FIG. 1, the financial services computer network 110 can received a product identifier (e.g. ABC123) corresponding to the financial product 102 such as a credit card, a cashier's check, etc. that is issued by a financial institution system.

The system 100 can record 304 the received product identifier in a database. The server 170 may receive the product identifier from the financial services computer network 110 and stores the product identifier in the database 178.

The system 100 can determine 306 select transport details for the financial product. In some configurations, the select transport details can include a select courier signifier and a select location zone. In some embodiments, the system 100 can determine select transport details based on one or more trust scores associated with a courier for delivery of the financial product. In one example, the one or more trust scores for the courier delivering the financial product can be based on a number of deliveries that were successfully delivered by that courier and/or the ratings received by the courier. In another example, the one or more trust scores for the courier delivering the financial product can be based on a number of smart contracts (that ensure that an authentic financial product is exchanged to a verified accepter) verified and enforced by the courier.

The system 100 can receive 308, in response to a holder scanning a transported product, the product identifier and actual transport details. In some configurations, the actual transport details can include a holder signifier and a scan location.

The system 100 can compare 310 the actual transport details with the select transport details. For example, the system 100 compares the scan location and the select location zone corresponding to the transported financial product from the financial services provider to the recipient.

The system 100 can communicate 312 with the financial services computer network, in response to determining that there is a discrepancy, to disallow the use of the financial product. In one example, the server 170 can communicate a notification such as “Unauthorized use of credit card is detected” to the financial services computer network 110 when the server 170 determines that there is a discrepancy.

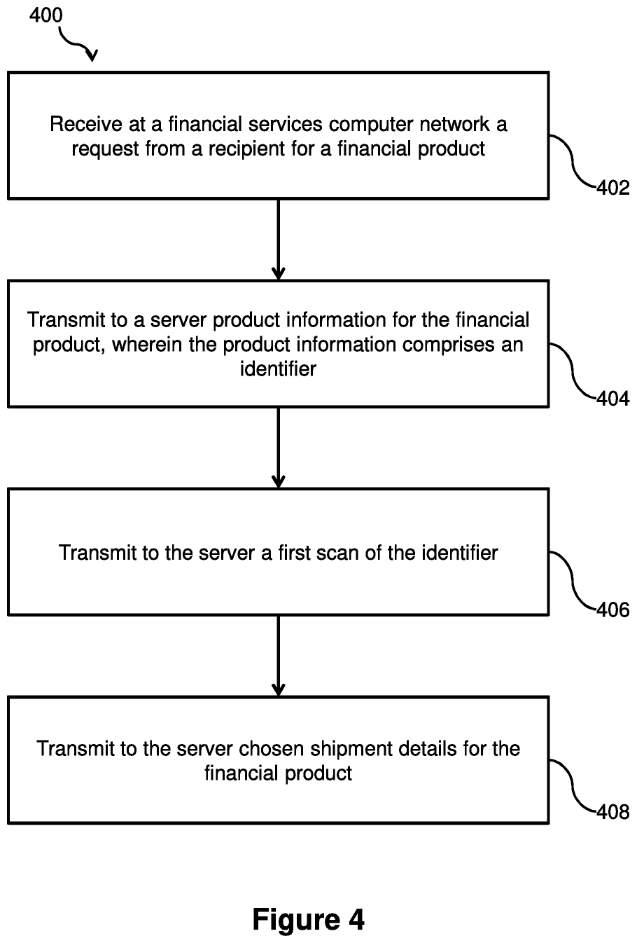

FIG. 4 is a flow diagram 400 showing processing that may occur within the system 100 of FIG. 1, according to some embodiments of the present disclosure. The flow diagram 400 of FIG. 4 may be performed by the system 100. Other entities may perform some or all of the steps of the process in other embodiments. Likewise, embodiments may include different and/or additional steps, or perform the steps in different orders.

The system 100 can receive 402 at a financial services computer network a request from a recipient for a financial product. For example, the financial services computer network 110 can receive a request from a recipient of a bank card issued by a financial institution system (e.g. Capital One).

The system 100 can transmit 404 to a server product information for the financial product. For example, the recipient device 190 can transmit to the server 170 product information for the received financial product. In some configurations, the product information includes an identifier associated with the received financial product.

The system 100 can transmit 406 to the server a first scan of the identifier. For example, the recipient device 190 can transmit to the server 170 a first scan of the product identifier based on a scanning of a unique bar/QR code corresponding to the financial product.

The system 100 can transmit 408 to the server chosen shipment details for the financial product. For example, the recipient device 190 can transmit to the server 170 chosen shipment details (e.g. a courier, a scan location, a time of scan, a recipient identifier, etc.) for the received financial product.

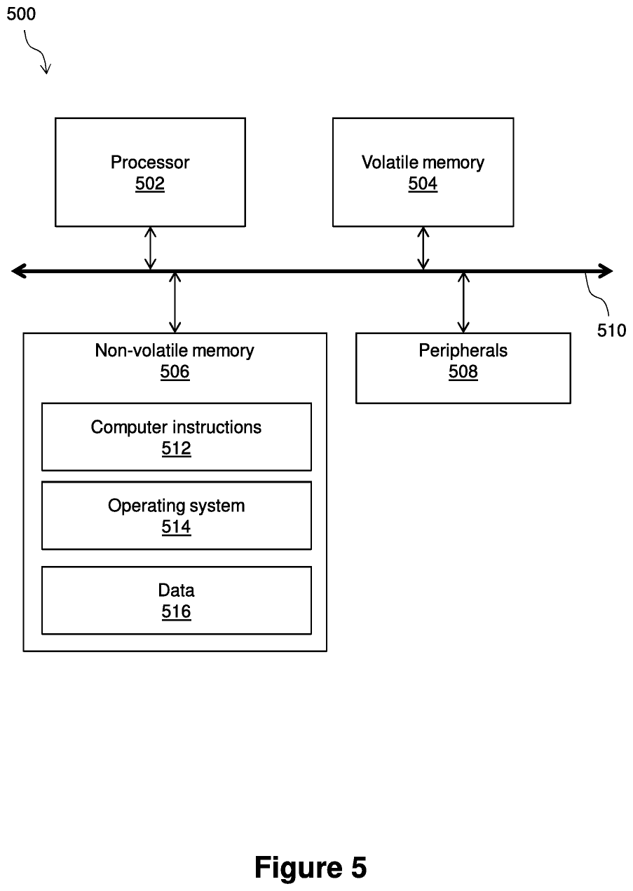

FIG. 5 is a block diagram of an example user device 500 that can perform at least part of the processing performed by the system 100 of FIG. 1, according to an embodiment of the present disclosure. The user device 500 may be an example of the intermediate device 130. The user device 500 may also be an example of the recipient device 190. User device 500 may include a processor 502, a volatile memory 504, a non-volatile memory 506 (e.g., hard disk), and peripherals 508, each of which is coupled together by a bus 510. Non-volatile memory 506 may be configured to store computer instructions 512, operating system 514, and data 516. In one example, computer instructions 512 are executed by the processor 502 out of the volatile memory 504. In some embodiments, the user device 500 corresponds to a virtual machine. In other embodiments, user device 500 corresponds to a physical computer.

Referring again to FIG. 5, processing may be implemented in hardware, software, or a combination of the two. In various embodiments, processing is provided by computer programs executing on programmable computers/machines that each includes a processor, a storage medium or other article of manufacture that is readable by the processor (including volatile and non-volatile memory and/or storage elements), at least one input device, and one or more output devices. Program code may be applied to data entered using an input device to perform processing and to generate output information.

### CONCLUSION

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

The system can perform processing, at least in part, via a computer program product, (e.g., in a machine-readable storage device), for execution by, or to control the operation of, data processing apparatus (e.g., a programmable processor, a computer, or multiple computers). Each such program may be implemented in a high level procedural or object-oriented programming language to communicate with a computer system. However, the programs may be implemented in assembly or machine language. The language may be a compiled or an interpreted language and it may be deployed in any form, including as a stand-alone program or as a module, component, subroutine, or other unit suitable for use in a computing environment. A computer program may be deployed to be executed on one computer or on multiple computers at one site or distributed across multiple sites and interconnected by a communication network. A computer program may be stored on a storage medium or device (e.g., CD-ROM, hard disk, or magnetic diskette) that is readable by a general or special purpose programmable computer for configuring and operating the computer when the storage medium or device is read by the computer. Processing may also be implemented as a machine-readable storage medium, configured with a computer program, where upon execution, instructions in the computer program cause the computer to operate. The program logic may be run on a physical or virtual processor. The program logic may be run across one or more physical or virtual processors.

Processing may be performed by one or more programmable processors executing one or more computer programs to perform the functions of the system. All or part of the system may be implemented as special purpose logic circuitry (e.g., an FPGA (field programmable gate array) and/or an ASIC (application-specific integrated circuit)).

Additionally, the software included as part of the concepts, structures, and techniques sought to be protected herein may be embodied in a computer program product that includes a computer-readable storage medium. For example, such a computer-readable storage medium can include a computer-readable memory device, such as a hard drive device, a CD-ROM, a DVD-ROM, or a computer diskette, having computer-readable program code segments stored thereon. In contrast, a computer-readable transmission medium can include a communications link, either optical, wired, or wireless, having program code segments carried thereon as digital or analog signals. A non-transitory machine-readable medium may include but is not limited to a hard drive, compact disc, flash memory, non-volatile memory, volatile memory, magnetic diskette, and so forth but does not include a transitory signal per se. In describing exemplary embodiments, specific terminology is used for the sake of clarity. For purposes of description, each specific term is intended to at least include all technical and functional equivalents that operate in a similar manner to accomplish a similar purpose.

Additionally, in some instances where a particular exemplary embodiment includes a plurality of system elements, device components or method steps, those elements, components or steps may be replaced with a single element, component, or step. Likewise, a single element, component, or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

1. A computer-implemented method for improving security of transporting a tangible financial product, the method comprising:
receiving, from a financial services computer network by a computer system comprising at least one processor, a product identifier for a financial product to be transported to a select recipient;
determining, by the computer system, a trust score for a courier from a blockchain, the trust score being based on a number of successful deliveries by the courier recorded on the blockchain;
selecting, by the computer system, the courier to transport the financial product based on the determined trust score;
determining, by the computer system, select transport details for the financial product, wherein the select transport details comprise a select courier signifier representing the selected courier and a select location zone;
recording, by the computer system, the product identifier and the select transport details in the blockchain;
receiving, by the computer system in response to a holder scanning the financial product after it has been transported, the product identifier and actual transport details, wherein the actual transport details comprise a holder signifier and a scan location;
recording, by the computer system, the actual transport details in the blockchain;
comparing, by the computer system, the actual transport details with the determined select transport details; and
communicating, by the computer system, with the financial services computer network, in response to determining that there is a discrepancy between the holder signifier and the select courier signifier or between the scan location and the select location zone, a notification causing use of the transported financial product to be disallowed.

2. The computer-implemented method of claim 1, wherein the actual transport details originate from the financial product independent of any container that encloses the financial product.

3. The computer-implemented method of claim 1, wherein the financial product comprises at least one of a radio-frequency identification (RFID) tag that comprises the product identifier, a chip embedded in a bank card that comprises the product identifier, a quick response code that comprises the product identifier, or a text string that comprises the product identifier.

4. The computer-implemented method of claim 1, further comprising determining a wishlist of couriers for delivering the financial product based on one or more trust scores stored in the blockchain.

5. The computer-implemented method of claim 4, further comprising determining the one or more trust scores stored in the blockchain based on a number of successful deliveries by each courier from the wishlist of couriers.

6. The computer-implemented method of claim 4, further comprising determining the one or more trust scores stored in the blockchain based on a number of smart contracts enforced by each courier from the wishlist of couriers.

7. The computer-implemented method of claim 1, further comprising:
receiving, from the financial services computer network, a second product identifier for a second financial product to be transported to a second select recipient at a second select delivery location;
determining second select transport details for the second financial product, wherein the second select transport details comprise a second select courier signifier and a second select location zone;
recording the second select transport details and the second product identifier in the blockchain;
receiving, in response to a second holder scanning the second financial product after it has been transported, the second product identifier and second actual transport details, wherein the second actual transport details comprise a second holder signifier and a second scan location;
recording the second actual transport details in the blockchain;
comparing the second actual transport details with the second select transport details to determine that there is no discrepancy;
and
communicating with the financial services computer network to allow the use of the second financial product in response to determining there is no discrepancy.

8. The computer-implemented method of claim 7, wherein the second financial product is a bank card comprising a surface that lacks a visible card number.

9. The computer-implemented method of claim 8, further comprising:
receiving, from the financial services computer network, in response to an authorized user of the bank card performing a transaction within a pre-defined location known to the financial services computer network, a report that the bank card has been activated.

10. The computer-implemented method of claim 8, further comprising:
receiving, from the financial services computer network, in response to an authorized user of the bank card activating the bank card, a report that the bank card has been activated.

11. A system for verifying authenticity of a transported financial product, the system comprising:
a database;
one or more processors;
an initiating module configured for execution by the one or more processors to:
receive, from a financial services computer network, a product identifier for a financial product to be transported to a select recipient;
determine a trust score for a courier from a blockchain, the trust score being based on a number of successful deliveries by the courier recorded in the block chain;
select the courier to transport the financial product based on the determined trust score;
determine select transport details for the financial product, wherein the select transport details comprise a select courier signifier representing the selected courier and a select location zone; and
record the product identifier and the select transport details in the blockchain;
a tracking module configured for execution by the one or more processors to:
receive, in response to a holder scanning the financial product after it has been transported, the product identifier and actual transport details, wherein the actual transport details comprise a holder signifier and a scan location;
record the actual transport details in the blockchain; and
compare the actual transport details with the select transport details; and
a verification module configured for execution by the one or more processors to:
communicate with the financial services computer network, in response to determining that there is a discrepancy between the holder signifier and the select courier signifier or between the scan location and the select location zone, a notification causing use of the financial product to be disallowed.

12. The system of claim 11, wherein the database comprises a wishlist of couriers determined based on one or more trust scores determined by the financial services computer network.

13. The system of claim 12, wherein the financial services computer network is configured to determine the one or more trust scores stored in the blockchain based on a number of successful deliveries by each courier from the wishlist of couriers.

14. The system of claim 12, wherein the financial services computer network is configured to determine the one or more trust scores stored in the blockchain based on a number of smart contracts enforced by each courier from the wishlist of couriers.

15. The system of claim 12, wherein the financial product comprises at least one of a radio-frequency identification (RFID) tag that comprises the product identifier, a chip embedded in a bank card that comprises the product identifier, a quick response code that comprises the product identifier, a text string that comprises the product identifier, or a Bluetooth device that comprises the product identifier.

16. A method for securely sending a financial product to a recipient, the method comprising
receiving, at a financial services computer network, a request from a recipient for a financial product;
transmitting, to a server coupled to the financial services computer network, product information for the financial product, wherein the product information comprises an identifier;
transmitting to the server a first scan of the identifier; and
transmitting to the server chosen shipment details for the financial product.

17. The method of claim 16, further comprising:
sending the financial product by mail within an opaque container that allows scanning of the financial product while the financial product is inside the container.

18. The method of claim 16, further comprising:
transmitting, to the server, information on activation of the card by an authorized user.

19. The method of claim 18, further comprising:
transmitting, to the server, a location information of a transaction performed by the authorized user of the card.

20. The method of claim 19, wherein the location information of the transaction includes one or more pre-defined locations known to the financial services computer network.
